(19) United States
(12) Patent Application Publication
(10) Pub. No.: US 2018/0153348 A1
(43) Pub. Date: Jun. 7, 2018

(54) OIL FILTER OF ELECTRIC FRYER

(71) Applicants: NINGBO BIYI ELECTRIC APPLIANCE CO., LTD, Yuyao (CN); URI MURAD, Miami Gardens, FL (US)

(72) Inventor: Kaimong MAN, Hong Kong (CN)

(73) Assignees: NINGBO BIYI ELECTRIC APPLIANCE CO., LTD, Yuyao (CN); URI MURAD, Miami Gardens, FL (US)

(21) Appl. No.: 15/367,689

(22) Filed: Dec. 2, 2016

(51) Int. Cl. A47J 37/12; B01D 29/31

(52) U.S. Cl. CPC A47J 37/1223; B01D 29/31; A47J 37/1209

(57) ABSTRACT

An oil filter unit at the pot body bottom of the machine body. The valve of the oil filter unit is at the rocker unit opposite end, and the other end is against the knob unit. The rocker pivot is located on rocker seat and entrance of oil box is located under the panel. The key point is that the knob unit of knob cover and knob. The knob cover is cylinder-shaped while the center of inner cylinder is equipped with column cover. Edge opening is located at the rocker end inside the knob cover and the opening is symmetrical to the balance slot in the center of the cylinder. The balance slot is against the rocker knob cover end for limit while one inner end of the balance slot is equipped with limit plate. The knob cover is driven by knob to realize rocking between knob cover and rocker.

### TECHNICAL FIELD

The present invention related to a household electric fryer, is an oil filter of electric fryer.

### BACKGROUND TECHNOLOGY

The household electric fryer is one of electric appliances for frying a variety of meat, vegetables, nuts and other food. With high heating rate, it is easy to operate and is the equipment specialized in frying food at home. At present, to avoid repeat use of cooking oil and to make waste oil collection easier, pot body of some household electric fryers have been improved in structure, i.e. add oil filter at the bottom of the pot body, and add oil box at the bottom of oil filter structure, to collect waste oil with oil filter structure and the oil box. In the same time, to make the said oil filtering and collecting structure be easier and safer, the knob or toggle switch has been adopted. The main working principle is at rocker structure. However, to have easier and safer operation, these structures and the safety interlock structure between knob and the oil box of existing similar products need to be further improved.

### INVENTION CONTENT

To overcome the said deficiencies, the invention is aimed to provide an oil filter of electric fryer, to solve technical matters of existing similar products, such as: poor designed interlock structure between knob and oil box, as well as safety and stability. The goal is achieved by following technical solutions.

An oil filter of electric fryer, comprising oil box, oil filter unit, rocker unit and knob unit, the oil filter unit is located at the bottom of the pot body of the machine body. The valve of the oil filter unit is at the opposite of one end of rocker of the rocker unit, and the other end of the rocker is against the knob unit. The pivot of the rocker is located on rocker seat. The valve consists of sealing plug, valve needle and spring, and the knob unit is located on the panel on the side of the machine body. The entrance of the oil box is located under the panel. The key point is that the knob unit consists of knob cover and knob. The knob cover is cylinder-shaped. Edge opening is located at the rocker end inside the knob cover, and the opening is symmetrical to the balance slot in the center of the cylinder. The balance slot is against the knob cover end of the rocker for limit. The knob cover is driven by the knob, and to realize the rocking between knob cover and the rocker. The said structure uses the balance slot at the opening on the side of the mouth of the knob cover, to tilt the rocker. The structure is simple, with convenient production and good stability.

The knob cover of the said knob unit snap-fit with the knob and fixed to the panel on the side of the machine body. The panel is integrated with the machine housing. The center of inner cylinder of the said knob cover is equipped with column cover. The balance slot is symmetrically located on edges on the sides of the column cover. The combined knob cover and the knob is convenient for installing knob cover and knob on panel or housing; the column cover of the knob cover is convenient for installing the knob cover on machine body with pin; while the designed 180° opening at balance slot symmetrically is able to meet the requirements for meeting between knob cover and rocker, and the range of limit plate.

The meet point between the said rocker and the knob cover is equipped with tip, and the edge slots on the sides of balance slot of the knob cover are aligned with the tip. The boss is located on the tip side of the said rocker, and the boss is aligned with the mouth of the knob cover, i.e. when the rocker is against the knob cover, the boss is outside the mouth of the knob cover. The tip of the said rocker is sloped down. When the rocker is against the knob cover, the balance slot of the tip and the knob cover are at the same plane. The structure design of the said tip is easy to operate the knob cover and the rocker. When the rocker is tilted, the tip is against the balance slot stably; the boss of the rocker is able to avoid the displacement between knob cover and the rockers, which acted as the limit, and further improved the operating stability of knob cover and rocker.

The meet point between the said rocker and the valve of the oil filter unit is equipped with tapered drain hole, whose inner diameter is equipped with the hollow hole. The raised balance column is located in the center of inner diameter of the tapered drain hole; while the level of the balance column is lower than the level of mouth of the tapered drain hole; when the rocker is against the knob cover, the balance column is against the valve needle of the valve. The said oil box beneath the tapered drain hole of the rocker is equipped with oil inlet, which is equipped with oil feed part with hollow hole and support rib. The oil feed part is integrated with oil box, or snap-fit and fastened with oil inlet of the oil box. The bracket is located above the oil inlet of the said oil box, and one end of the oil filter unit that stretch out of the pot body is fastened to the bracket. The bracket is arched. The tapered drain hole of the rocker and the oil feed part of the oil box are inside the bracket. The said oil box is equipped with oil cap. One corner of the oil cap is equipped with oil outlet cap, and the cap is equipped with air vent. The said structure is convenient for the rocker to open the valve by pushing valve needle through balance column; the tapered drain hole and the oil inlet is convenient for waste oil flows of the pot body into the oil box through the rocker and the oil feed part, and prevent the waste oil from splashing or overflowing; the bracket may limit the oil box, and prevent the pot body from sinking, and further prevent the waste oil from splashing or overflowing.

The limit plate is beneath the said knob cover, and the limit plate is located at one inner end of the balance slot. The limit plate is aligned with the limit slot of the oil box. When knob tilts rocker, the limit plate of knob cover will insert into the limit slot, and the oil box will be limited in the machine body. The structure makes it impossible for oil box to be taken out during waste oil collection, so the security during oil collection has been guaranteed. When the knob cover is separated from the rocker and the limit plat of the knob cover is separated from limit slot, the oil box can be taken out from the machine body.

The cover plate is located on the panel side of the said oil box, and the cover plate is equipped with pull slot. The cover plate is integrated with the side of the oil box. The cover plate and the panel are at the same plane. It makes it easy to pull out or push into the oil box through the cover plate, and to avoid scalding injury, which may also be achieved by the said limit slot or cover plate.

The spring is located at the bottom of the knob cover end of the said rocker, and two ends of the spring are against the rocker and rocker seat respectively. The said structure is convenient for the rocker to reset after use, which can also been realized by the rocker with gravity.

The invention is reasonably designed. It is easy to use and clean the oil box, with good sealing and security of waste oil collection; mainly served for electric fryer with oil collection, and improving structure of similar products.

### BRIEF DESCRIPTION OF THE ILLUSTRATIONS

FIG. 1 is structural view of the invention, and the dotted line outlines the machine body.

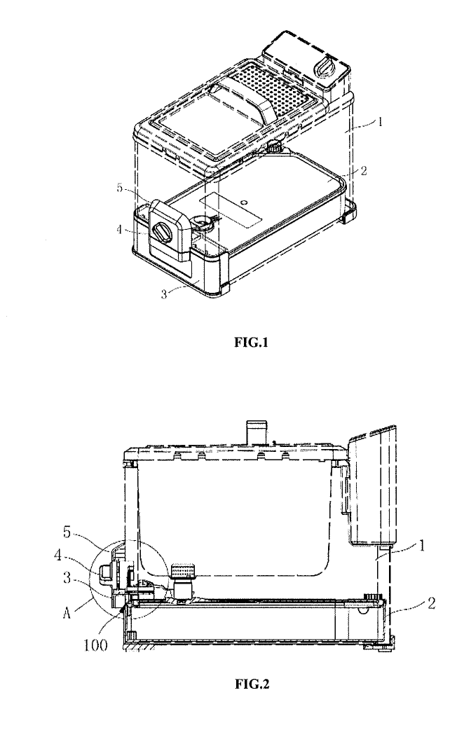

FIG. 2 is cross-sectional view of FIG. 1, with Part A framed.

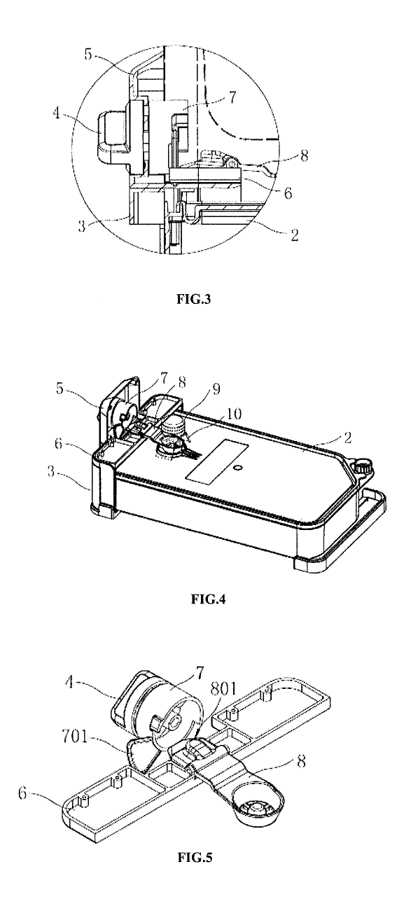

FIG. 3 is enlarged view of A part of FIG. 2.

FIG. 4 is structural view of the invention, and the dotted line outlines the oil filter unit.

FIG. 5 is structural view of rocker unit of FIG. 4.

Number and Name: 1. Machine Body 2. Oil Box 3. Cover Plate 4. Knob 5. Panel 6. Rocker Seat 7. Knob Cover 701. Limit Plate 8. Rocker 801. Tip 9. Filter Screen Unit 10. Bracket 100. Limit Slot

### DESCRIPTION OF THE PREFERRED EMBODIMENT

Turning to the illustrations, and further description of structure and usage of the invention is provided. As shown in FIG. 1-4, the oil filter of electric fryer, comprising oil box2, oil filter unit9, rocker unit and knob unit, the oil filter unit is located at the bottom of the pot body of the machine body1. The valve of the oil filter unit is at the opposite of one end of the rocker8 of rocker unit, and the other end of the rocker is against the knob unit. The valve consists of sealing plug, valve needle and spring. The pivot of the rocker is located on rocker seat6, and the knob unit is located on the panel5 on the side of the machine body. The entrance of the oil box is located under the panel. The knob unit consists of knob cover7 and knob4; the knob cover of the knob unit snap-fit with the knob and fixed to the panel on the side of the machine body. The panel is integrated with the machine housing. The knob cover is cylinder-shaped. Edge opening is located at the rocker end inside the knob cover, and the opening is symmetrical to the balance slot in the center of the cylinder. The balance slot is against the knob cover end of the rocker for limit. The limit plate701 is beneath the knob cover, and the limit plate is located at one inner end of the balance slot. The limit plate is aligned with the limit slot100 of the oil box. The meet point between the rocker and the knob cover is equipped with tip801, and the edge slots on the sides of balance slot of the knob cover are aligned with the tip. The boss is located on the tip side of the rocker, and the boss is aligned with the mouth of the knob cover, i.e. when the rocker is against the knob cover, the boss is outside the mouth of the knob cover. The tip of the rocker is sloped down. When the rocker is against the knob cover, the balance slot of the tip and the knob cover are at the same plane. The meet point between the rocker and the valve of the oil filter unit is equipped with tapered drain hole, whose inner diameter is equipped with the hollow hole. The raised balance column is located in the center of inner diameter of the tapered drain hole; while the level of the balance column is lower than the level of mouth of the tapered drain hole; when the rocker is against the knob cover, the balance column is against the valve needle of the valve. The oil box beneath the tapered drain hole of the rocker is equipped with oil inlet, which is equipped with oil feed part with hollow hole and support rib. The oil feed part is integrated with oil box. The bracket10 is located above the oil inlet of the oil box, and one end of the oil filter unit that stretch out of the pot body is fastened to the bracket. The bracket is arched. The tapered drain hole of the rocker and the oil feed part of the oil box are inside the bracket. The oil box is equipped with oil cap. One corner of the oil cap is equipped with oil outlet cap, and the cap is equipped with air vent. The cover plate3 is located on the panel side of the oil box, and the cover plate is equipped with pull slot. The cover plate is integrated with the side of the oil box. The cover plate and the panel are at the same plane.

During the use, the knob cover is driven by knob. When knob tilts the rocker, the limit plate of knob cover will insert into the limit slot, and the oil box will be limited in the machine body. In the same time, the rocker opens the valve of oil filter unit by pushing valve needle through balance column, and the waste oil flows into the oil box through the rocker and the oil feed part. Rotate the knob to reset, when the knob cover is separated from the rocker and the limit plat of the knob cover is separated from limit slot, the oil box can be taken out from the machine body.

According to structural features and using characteristics of the embodiment, the knob cover may also be fastened to the pin inside the machine body through column cover in the center of inner cylinder of the machine body, so as to have a more stable rotation of the knob cover. Beside, the oil feed part may also be integrated with oil inlet of the oil box as plastic part; the limit slot that inserted into the limit plate of the knob cover may also be equipped with cover plate. The spring may also be placed at the bottom of the knob cover end of the rocker, with two ends of the spring against the rocker and rocker seat respectively, for the rocker to reset after use.

1. An oil filter of electric fryer, comprising oil box, oil filter unit, rocker unit and knob unit, the oil filter unit is located at the bottom of the pot body of the machine body, the valve of the oil filter unit is at the opposite of one end of rocker of the rocker unit, and the other end of the rocker is against the knob unit, the valve consists of sealing plug, valve needle and spring, the pivot of the rocker is located on rocker seat, and the knob unit is located on the panel on the side of the machine body, the entrance of the oil box is located under the panel, the key point is that the knob unit consists of knob cover and knob, the knob cover is cylinder-shaped, edge opening is located at the rocker end inside the knob cover, and the opening is symmetrical to the balance slot in the center of the cylinder, the balance slot is against the knob cover end of the rocker for limit; the knob cover is driven by the knob, and to realize the rocking between knob cover and the rocker.

2. The oil filter of electric fryer according to claim 1, wherein the knob cover of the knob unit snap-fit with the knob and fixed to the panel on the side of the machine body, the panel is integrated with the machine housing.

3. The oil filter of electric fryer according to claim 2, wherein the center of inner cylinder of the knob cover is equipped with column cover; the balance slot is symmetrically located on edges on the sides of the column cover.

4. The oil filter of electric fryer according to claim 1, wherein the meet point between the rocker and the knob cover is equipped with tip, and the edge slots on the sides of balance slot of the knob cover is aligned with the tip.

5. The oil filter of electric fryer according to claim 4, wherein the boss is located on the tip side of the rocker, and the boss is aligned with the mouth of the knob cover, when the rocker is against the knob cover; the boss is outside the mouth of the knob cover.

6. The oil filter of electric fryer according to claim 4, wherein the tip of the rocker is sloped down, when the rocker is against the knob cover, the balance slot of tip and knob cover are at the same plane.

7. The oil filter of electric fryer according to claim 4, wherein the meet point between the rocker and the valve of the oil filter unit is equipped with tapered drain hole, whose inner diameter is equipped with the hollow hole, the raised balance column is located in the center of inner diameter of the tapered drain hole, while the level of the balance column is lower than the level of mouth of the tapered drain hole; when the rocker is against the knob cover, the balance column is against the valve needle of the valve.

8. The oil filter of electric fryer according to claim 7, wherein the oil box beneath the tapered drain hole of the rocker is equipped with oil inlet, which is equipped with oil feed part with hollow hole and support rib, the oil feed part is integrated with oil box, or snap-fit and fastened with oil inlet of the oil box.

9. The oil filter of electric fryer according to claim 8, wherein the bracket is located above the oil inlet of the oil box, and one end of the oil filter unit that stretch out of the pot body is fastened to the bracket, the bracket is arched, the tapered drain hole of the rocker and the oil feed part of the oil box are inside the bracket.

10. The oil filter of electric fryer according to claim 9, wherein the oil box is equipped with oil cap, one corner of the oil cap is equipped with oil outlet cap, and the cap is equipped with air vent.

11. The oil filter of electric fryer according to claim 1, wherein the limit plate is beneath the knob cover, and the limit plate is located at one inner end of the balance slot, the limit plate is aligned with the limit slot of the oil box, when knob tilts the rocker, the limit plate of knob cover will insert into the limit slot, and the oil box will be limited in the machine body.

12. The oil filter of electric fryer according to claim 11, wherein the cover plate is located on the panel side of the oil box, and the cover plate is equipped with pull slot, the cover plate is integrated with the side of the oil box, the cover plate and the panel are at the same plane.

13. The oil filter of electric fryer according to claim 12, wherein the limit slot is located on the cover plate.

14. The oil filter of electric fryer according to claim 1, is wherein the spring is located at the bottom of the knob cover end of the rocker, and two ends of the spring are against the rocker and rocker seat respectively.
